(19) United States
(12) Patent Application Publication
(10) Pub. No.: US 2022/0318938 A1
(43) Pub. Date: Oct. 6, 2022

(54) Method to provide digital design content

(71) Applicant: KREATION KABUSHIKI KAISYA, Tokyo (JP)

(72) Inventor: Tomoya OGAWA, SETAGAYA-KU (JP)

(21) Appl. No.: 17/714,747

(22) Filed: Apr. 6, 2022

(30) Foreign Application Priority Data
Apr. 6, 2021 (JP) 2021-064990

(51) Int. Cl. G06Q 50/18

(52) U.S. Cl. CPC G06Q 50/184

(57) ABSTRACT

To realize efficient and safe distribution promotion of design contents. In an embodiment of the present invention, a method for providing digital contents, wherein a control unit of a server terminal includes: receiving transaction information of digital contents from a user terminal, and recording the transaction information in a blockchain as transaction information associated with a non-fungible token associated with the digital contents, wherein the transaction information includes at least right holder information of the digital contents, and wherein the right holder information includes copyright holder information and/or ownership holder information.

### TECHNICAL FIELD

The present invention relates to a method for providing digital design contents.

### BACKGROUND ART

It is common for a designer to devise a design for a fashion brand and apply the devised design to clothing items such as clothes, and sold at real stores, and the like, but there is a growing demand to promote the application and distribution of such designs to more products.

For example, Patent Literature 1 discloses a technique related to a platform for registering designs by its own or other users who sell products, applying and selling product designs such as smartphone cases, T-shirts, and tote bags, etc., according to the needs of users.

### PRIOR ART LIST

### Patent Literature

[Patent Literature 1] Japanese Unexamined Patent Application Publication No. 2015-219902

### SUMMARY OF THE INVENTION

### Technical Problem

However, although the technique disclosed in Patent Literature 1 has a certain effect on promoting the distribution of designs, it is about a scheme that applies a registered design to a real product to the utmost and enables the purchase of that product. Considering the necessity of manufacturing real products, there is an aspect that cannot necessarily be said to promote efficient distribution. Additionally, it is difficult to grasp and manage the right holder when distributing the design, and no consideration has been given to the arrangement of legal and rights relationships and risk management.

Therefore, an object of the present invention is to realize efficient and highly safe distribution promotion of design contents.

### Technical Solution

In an embodiment of the present invention, a method for providing digital contents, wherein a control unit of a server terminal includes: receiving transaction information of digital contents from a user terminal, and recording the transaction information in a blockchain as transaction information associated with a non-fungible token associated with the digital contents, wherein the transaction information includes at least right holder information of the digital contents, and wherein the right holder information includes copyright holder information and/or ownership holder information.

### Advantageous Effects

According to the present invention, it is possible to realize efficient and safe distribution promotion of design contents.

### BRIEF DESCRIPTION OF THE DRAWINGS

FIG. 1 is a block configuration diagram showing a digital content providing system according to a first embodiment of the present invention.

FIG. 2 is a conceptual diagram showing right information related to digital contents according to the first embodiment of the present invention.

FIG. 3 is a functional block configuration diagram showing the server terminal 100 of FIG. 1.

FIG. 4 is a functional block configuration diagram showing the designer terminal 200 of FIG. 1.

FIG. 5 is a diagram showing an embodiment of design data stored in the server 100.

FIG. 6 is a diagram showing an embodiment of designer data stored in the server 100.

FIG. 7 is a diagram showing an embodiment of digital media data stored in the server 100.

FIG. 8 is a diagram showing an embodiment of transaction data stored in the server 100.

FIG. 9 is a diagram showing an embodiment of details of right holder information among transaction data stored in the server 100.

FIG. 10 is a flowchart showing a method of providing digital contents according to the first embodiment of the present invention.

FIG. 11 is a flowchart showing a method of performing a transaction recording of digital contents according to the first embodiment of the present invention.

### DETAILED DESCRIPTION OF THE EMBODIMENTS

Hereinafter, embodiments of the present invention will be described with reference to the accompanying drawings. Further, the embodiments described below do not unreasonably limit the content of the present invention described in the claims. Further, not all of components shown in the embodiments are essential components of the present invention.

### <Configuration>

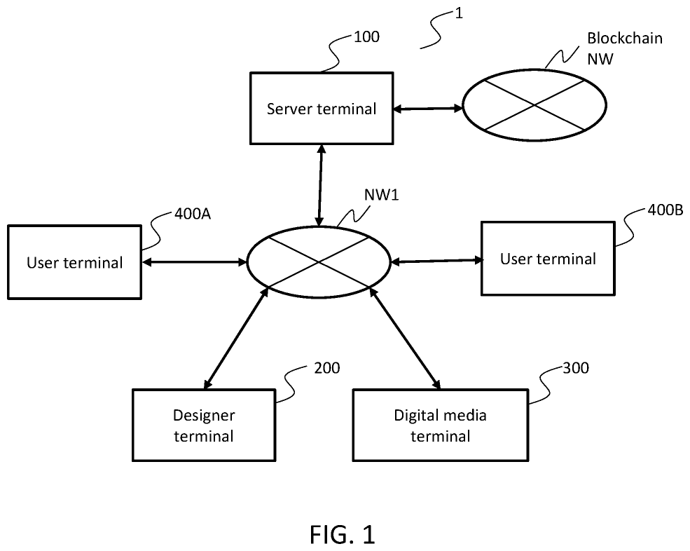

FIG. 1 is a block configuration diagram showing a digital content providing system according to a first embodiment of the present invention. This system 1 includes a server terminal 100 that stores design information and provides design information to a digital media, a designer terminal 200 that provides design information, and a digital media terminal 300 (e.g., as the web media, Facebook (registered trademark), Yahoo! (registered trademark), game service providers that provide online games, etc.) that provides digital information to users as a product. Further, this system 1 includes user terminals 400A and 400B which purchase products provided via a digital media terminal 300, wherein a blockchain network for recording right information related to digital information products, transaction records when users purchase products directly from service providers operating marketplaces as primary markets or digital media, transaction record when transaction of a product is performed as a secondary market between users, and/or royalties obtained based on sales of digital media related to products is connected to the server terminal 100. Further, for convenience of explanation, each terminal is described as a single terminal or a specific number, but is not limited in the number, and may be composed of a plurality of designer terminals, a plurality of digital media terminals, and a plurality of user terminals.

A server terminal 100, a designer terminal 200, a digital media terminal 300, and user terminals 400A and 400B are respectively connected via a network NW1. The network NW is composed of the Internet, an intranet, a wireless LAN (Local Area Network), a WAN (Wide Area Network), and the like.

The server terminal 100 and the digital media terminal 300 may be a general-purpose computer such as a workstation or a personal computer, or may be logically realized by cloud computing.

The server terminal 100 may receive transaction information related to transactions involving products related to digital information executed between the digital media terminal 300 and the user terminal 400A, etc., or between user terminals 400A and 400B, etc. as described above, and record a non-fungible token (hereinafter referred to as “NFT”) associated with a product by an identifier or the like in a blockchain network together with other transaction information. NFT is, for example, a token issued by Ethereum's “ERC721” standard, which is a platform for blockchain networks, which is a unit of data recorded in a blockchain network, and can show unique digital assets such as products related to digital information such as image data and moving image data, and has a non-substitutable character. While the above products can be duplicated on the network, the NFT is recorded and traceable on the blockchain together with the smart contract, so that it is possible to prove the transaction information including the details and history of the right holder, the owner information and the like. Further, by using a smart contract here, a contract related to a transaction between a digital media and a user or between users can be automatically created, approved and executed, without going through a third party. Further, the smart contract enables parties to a transaction and a third party to refer to the transaction information without going through the server terminal, which enhances the convenience of a service and reduces the operation cost.

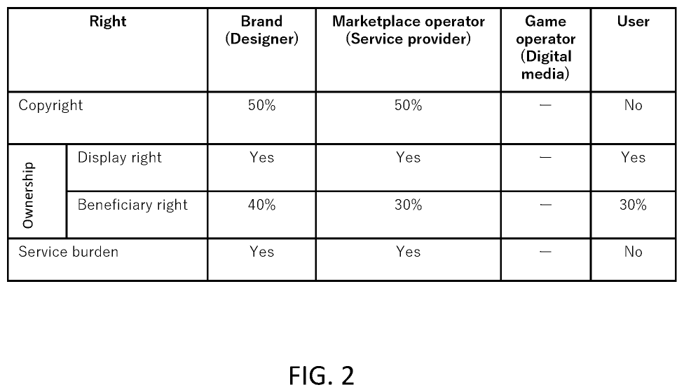

Here, as shown in FIG. 2, for the products (digital contents) related to design information created by the brand owner (designer), the right information is set in advance in relation to a plurality of businesses operators and users (purchasers). For example, even the case where the copyright, including the decision-making right to decide the usage of digital contents, is jointly owned by the brand owner and the marketplace operator, and the game operator jointly owns the copyright, is assumed. Further, ownership with a bond nature have been established, including beneficiary rights based on sales when digital contents are sold to users as a primary market via a marketplace operator vice operator) from the brand owner, or when they are sold from a brand owner via a marketplace operator (service operator) and a game operator (digital media), beneficiary rights based on sales when digital contents are sold from the user as a secondary market who purchased digital contents to other users in a primary market, or beneficiary rights to receive royalties based on the sales of game operators related to digital contents, or display rights to display digital content as the owner of digital contents (note that the ownership is not limited to these, and the parties can freely set it.). Here, the beneficiary right can distribute profits between the brand owner and the marketplace operator for buying and selling digital contents in the primary market, and can also distribute a part of the brand owner's beneficiary rights (e.g., 30% of all beneficiary rights) to users who are digital content purchasers in the secondary market. Additionally, the service burden related to digital contents can be set for a given person (This is just an example, and the target of distribution and the distribution ratio can be set freely). Thereby, it is possible to encourage the use of digital contents and provide a structure in which profits are returned to each party, including the brand owner, each time the digital content is distributed in each market. The digital content is managed in association with the NFT as unique data, and the above rights information can also be recorded in advance in the blockchain network as a NFT, or may be recorded when a transaction occurs between the parties.

The designer terminal 200 and the user terminals 400A and 400B are, for example, information processing devices such as a personal computer and a tablet terminal, but may be configured by a smartphone, a mobile phone, a PDA, or the like.

In the present embodiment, the system 1 includes a server terminal 100, a designer terminal 200, a digital media terminal 300, and a user terminal 400, Although it is described as a configuration in which a user of each terminal performs an operation on the server terminal 100 using each terminal, the server terminal 100 may be configured as stand-alone, and may include a function directly operated by each user in the server terminal itself.

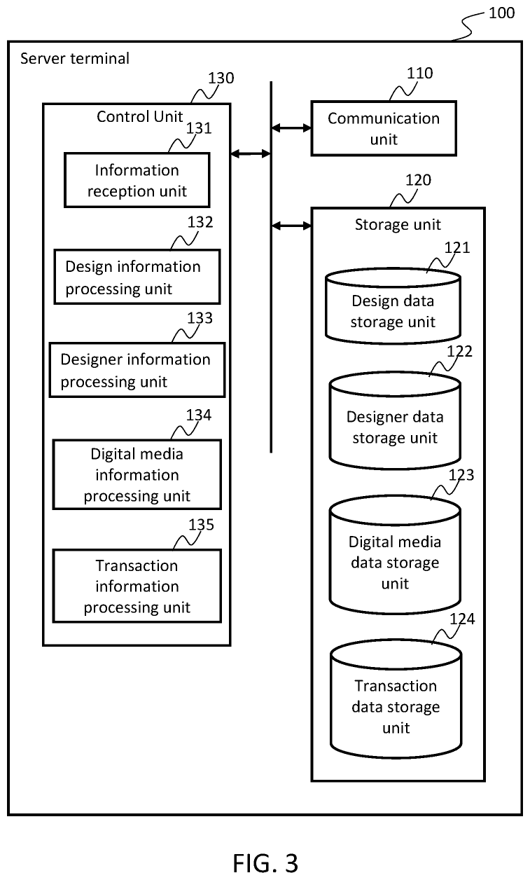

FIG. 3 is a functional block configuration diagram of the server terminal 100 of FIG. 1. The server terminal 100 includes a communication unit 110, a storage unit 120, and a control unit 130.

The communication unit 110 is a communication interface for performing communication with a designer terminal 200 and a digital media terminal 300 via a network NW. For example, communication is performed in accordance with communication standards such as TCP/IP (Transmission Control Protocol/Internet Protocol).

The storage unit 120 stores programs, input data, and the like for executing various control processes and functions in the control unit 130, and is composed of a RAM (Random Access Memory), a ROM (Read Only Memory), and the like. Further, the storage unit 120 includes a design data storage unit 121 which stores various data related to design, a designer data storage unit 122 which stores various data related to designer, a digital media data storage unit 123 which stores various data related to digital media, and a transaction data storage unit 124 which stores various data related to transactions, A database (not shown) that stores various data be constructed outside the storage unit 120 or the server terminal 100.

The control unit 130 executes the program stored in the storage unit 120, thereby controlling the overall operation of the server terminal 100, and is composed of a CPU (Central Processing Unit), a GPU (Graphics Processing Unit), and the like, As a function of the control unit 130, it includes an information reception unit 131 which receives information from each terminal, a design information processing unit 132 which refers to and processes various data related to design, a designer information processing unit 133 which refers to and processes various data related to designers, a digital media information processing unit 134 which refers to and processes various data related to digital media, and a transaction information processing unit 135 which manages transactions of products composed of digital information. The information reception unit 131, the design information processing unit 132, the designer information processing unit 133, the digital media information processing unit 134, and the transaction information processing unit 135 are started by a program stored in the storage unit 120 and executed by the server terminal 100 which is a computer (electronic computer).

The information reception unit 131 is provided by the server terminal 100, and receives information from the designer terminal 200 and the digital media terminal 300 via the communication unit 110. For example, design information (e.g., design data 1000 or the like described later) is received from the designer terminal 200 and the design information (e.g., a request far use of design information, information related to a product to which design information is applied, etc.) used by the digital media is received from the digital media terminal 300, respectively.

The design information processing unit 132 refers to various data related to the design received from the designer terminal 200 (e.g., design data 1000 described later) and performs predetermined processing.

The designer information processing unit 133 refers to various data related to the designer (e.g., designer data 2000 described later) received from the designer terminal 200 and performs predetermined processing.

The digital media information processing unit 134 refers to information related to digital media (e.g., digital media data 3000 described later) and performs predetermined processing.

Further, the control unit 130 may have an image generation unit (not shown), and may generate image information that is displayed via the user interface of the designer terminal 200 and the digital media terminal 300 according to a request. For example, by using images and text data (not shown) stored in the storage unit 120 as materials, various images and texts are arranged in a predetermined area of the user interface based on a predetermined layout rule, thereby creating a user interface. Processing related to the image generation unit can also be executed by GPU (Graphics Processing Unit).

Although not shown, the digital media terminal 300 has the same basic configuration as the server terminal 100, and the various data stored in the storage unit and the contents processed by the control unit differ depending on the attributes of the digital media and the contents of the services and contents provided to the user terminal 400. The whole or a part of the data (e.g., product information) included in the digital media data 3000 can he stored in the storage unit of the digital media terminal 300 and may be referenced and processed in the control unit.

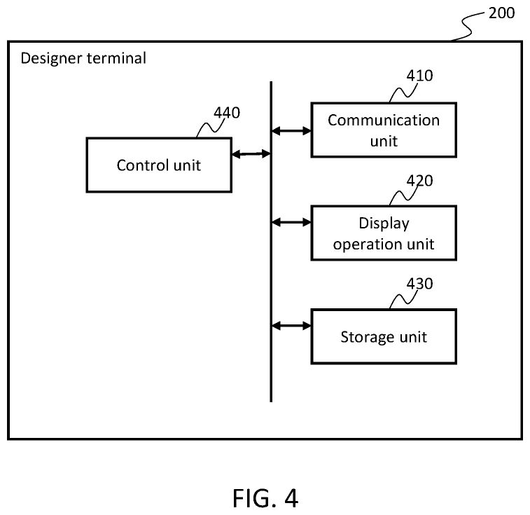

FIG. 4 is a functional block configuration diagram showing the designer terminal 200 of FIG. 1. The designer terminal 200 includes a communication unit 410, a display operation unit 420, a storage unit 430, and a control unit 440.

The communication unit 410 is a communication interface for performing communication with the server terminal 100 via the network NW, and communication is performed according to communication standards such as TCP/IP, for example.

The display operation unit 420 is a user interface used by the designer to input instructions and display text, images, or the like according to the input data from the control unit 440. When the digital media terminal 300 comprises a personal computer, it comprises a display, a keyboard, and a mouse, and when the digital media terminal 300 comprises a smartphone or a tablet terminal, it comprises a touch panel or the like. The display operation unit 420 is started by a control program stored in the storage unit 430 and executed by the designer terminal 200 which is a computer (electronic computer).

The storage unit 430 stores various control processes, programs for executing each function in the control unit 440, input data, and the like, and comprises a RAM, a ROM, and the like.

Further, the storage unit 430 temporarily stores the communication content with the server terminal 100.

The control unit 440 executes the program stored in the storage unit 430 and thus controls the entire operation of the digital media terminal 300 and comprises a CPU, a GPU, and the like.

The user terminal 400 has the same basic configuration as the designer terminal 200, and can he appropriately modified according to the purpose and use, and detailed description thereof will be omitted.

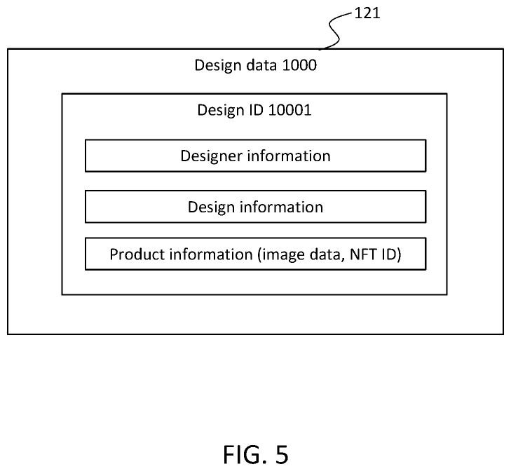

FIG. 5 is a diagram showing an embodiment of design data stored in the server 100.

The design data 1000 shown in FIG. 5 stores various data related to the design provided by the designer. In FIG. 4, an example of one design (a design identified by the design ID “10001”) is shown for convenience of explanation, but information on multiple designs can be stored. As various data related to designs, for example, designer information related to the designer (the designer's name or title, address or location, fashion brand to which the designer belongs, designer profile information, etc.), design information related to the design (design image data, design description information, price information, pattern information based on shape and color, etc., information on the design product sold at real stores, etc., information on fashion brands and real stores, and the like that sell design products, advertisement information on the design products sold at real stores, etc.), product information related to the product to which the design is applied (provided digital media name, product image data, right holder information (copyright holder and/or ownership holder information), ID for associating with NFT, etc.) can be included.

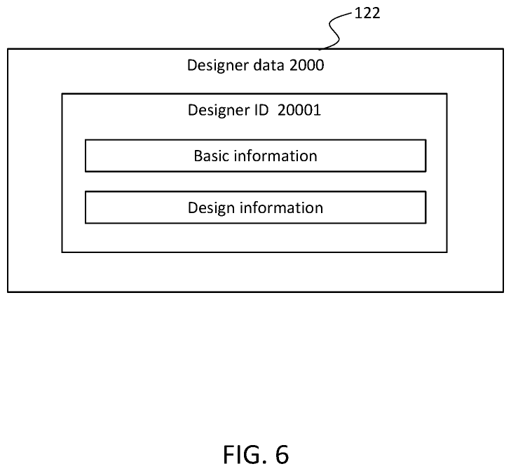

FIG. 6 is a diagram showing an embodiment of designer data stored in the server 100.

The designer data 2000 stores various data related to the designer. In FIG. 5, an example of one designer (designer identified by the designer ID “20001”) is shown for convenience of explanation, but information related to multiple designers can be stored. As various data related to the designer, for example, designer basic information (designer's name or title, address or location, fashion brand to which the designer belongs, designer profile information, etc.), design information related to the design (design image data, design description information, price information, pattern information based on shape and color, etc. information on design products sold at real stores, fashion brands, real stores, and the like that sell design products, information related to the real stores, advertisement information for design products sold at real stores, etc.) may be included.

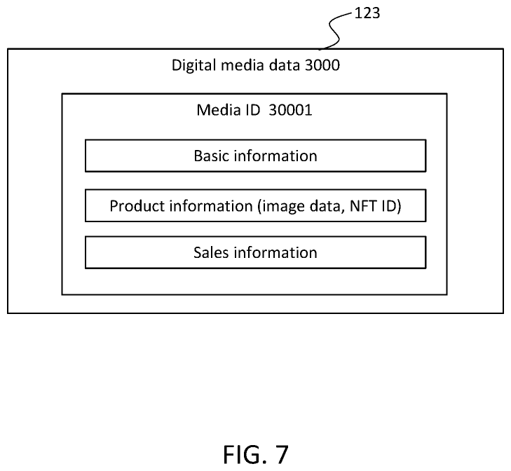

FIG. 7 is a diagram showing an embodiment of digital media data stored in the server 100.

The digital media data 3000 stores various data related to digital media. In FIG. 7, an example of one digital medium (digital media identified by the digital media ID “30001”) is shown for convenience of explanation, but information related to a plurality of digital media can be stored. As various data related to digital media, for example, basic information related to digital media (digital media organization name, address or location, service name, digital media profile information, service description information, etc.), product information related to products that digital media applies the design information and sells (seller information, product image data, product description information, price information, pattern information based on shape and colour, etc., right holder information (copyright holder and/or ownership holder information, ID for associating with NFT, etc.), product sales information (sales information (sales amount, breakdown, transition, etc.), marketing information (user attributes, etc.)) may be included.

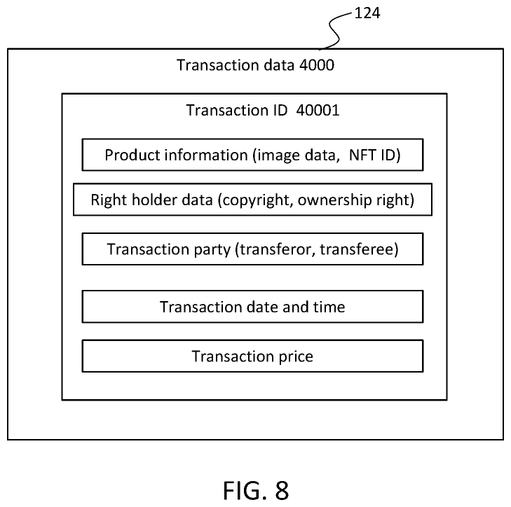

FIG. 8 is a diagram showing an embodiment of transaction data stored in the server 100.

The transaction data 4000 stores various data related to the transaction of products related to digital information. In FIG. 8. an example of one transaction (digital media identified by the transaction ID “40001”) is shown for convenience of explanation, but information related to a plurality of transactions can be stored. As various data related to transactions, for example, product information (product image data, product description information, price information, pattern information based on shape and color, ID for associating with NFT, etc.), right holder information (copyright holder information of copyright related to products, ownership holder of ownership (owner's right) related to products, etc.), transaction information (information related to the parties involved in the transaction of the product (transferor, transferee of the product)), transaction date and time (date and time of executing the transaction, etc.), transaction price (sales price of the transaction product, etc.) may be included. Here, as described above, information such as product information and right holder information can be managed as information associated with the NFT.

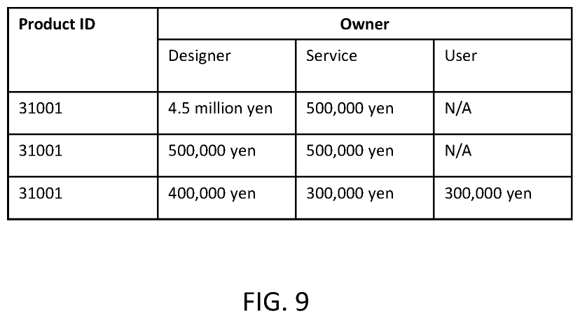

FIG. 9 is showing an embodiment of details of right holder information among transaction data stored in the server 100.

As shown in FIG. 9, as the right holder information, the owner information related to the beneficial right of a product can be stored in association with the ID that identifies the product. For example, the owner information on a specific product may include at least the designer information that devised the digital content (here, designers can also include product sellers such as brand owners), service provider information as a marketplace operator that mediates transactions of the design contents, and user information that is the party for performing transaction of the digital contents, or a combination thereof. Here, the owner information is information indicating the beneficial right of a product. When performing transaction of a product, it may include information that serves as a standard (distribution rate) for profit distribution based on the transaction price. For example, the designer, the service provider, and the user can execute the revenue distribution at the rates of 40%, 40%, and 30%, respectively, with respect to the revenue obtained from the transaction. Further, the breakdown of owners and rates can be changed based on the distribution form of the product. For example, when a product is sold to a user from digital media as a primary market or a secondary market, the owner may be set as a designer and a service provider. Owners can be set as designers, service providers, and users for royalties collected from sales of digital media related to products. Further, regarding the rate, the selling price is apportioned between the designer and the service provider by 90% and 10% for the transaction in the primary market where the product is sold from the designer to the user via a service provider. For transactions in the secondary market where a product is sold from a product purchasing user to another user, for example, the commission received by the service provider can be set to be apportioned and distributed by 50% and 50%. Further, the distribution of royalties obtained from digital media can be set to 40%, 30%, and 30%, respectively, among designers, service providers, and users. Further, as shown in FIG. 2, in addition to the owner's right, the copyright that determines the usage of the product as digital information can be separately set, for example, jointly owned by the designer and the service provider.

### <Flow of Processing>

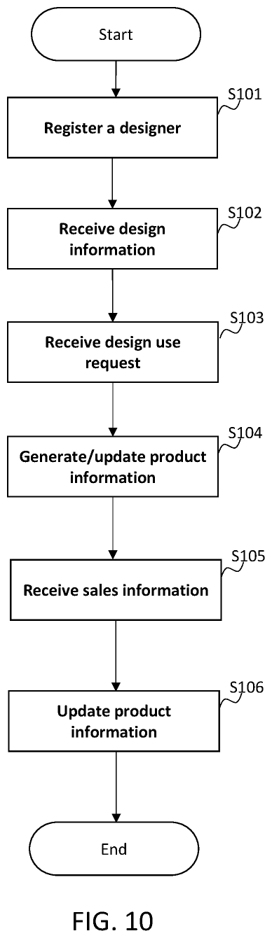

With reference to FIG. 10, a flow of processing of a method for providing digital contents executed by the system 1 of the present embodiment will be described. FIG. 10 is an example of a flowchart showing a method of providing digital contents according to a first embodiment of the present invention.

First, in order to use the system 1 as the process of step S101, when the designer accesses the server terminal 100 using a web browser or an application of each terminal and uses the service for the first time, the designer performs user registration by inputting the basic information of the designer mentioned above. Here, the designer can substitute the user registration in cooperation with the user account of the existing digital service or SNS service (Facebook (registered trademark), etc.). The information reception unit 131 of the control unit 130 of the server terminal 100 receives information necessary for designer registration from the designer terminal 200 via a communication unit 110. The designer information processing unit 133 of the control unit 130 of the server terminal 100 stores the received information in a designer data storage unit 122 of the storage unit 120 as a designer data 2000. If the designer has already registered as a designer and has already acquired a user account, for example, the service can be used by logging in after receiving predetermined authentication such as entering an ID and password. After this authentication, a predetermined user interface is provided via a website, application, etc., and the process proceeds to the next step.

Next, as the process of step S102, the information reception unit 131 of the control unit 130 of the server terminal 100 receives the design information from the designer terminal 200 via the communication unit 110. As design information, the designer transmits the devised design (e.g., a design applied to clothing or the like as digital contents) as image data to the server terminal 100 via the design terminal 200. Here, the image data may be data that stores the design information input by the designer for digital contents by using an arbitrary development tool, or may be data obtained by capturing and scanning a product such as clothing sold in a real store or the like. Further, the image data can be in a format (file format, size) specified by the marketplace service provider that operates the server terminal 100. Also, other design information may include design description information, price information, pattern information based on shape and colour, design product information sold at real stores, etc., information related to fashion brands selling design products, real stores, etc., advertisement information on design products sold at real stores, etc. The digital information processing unit 132 of the control unit 130 of the server terminal 100 stores the received design information as design data 100 in the design data storage unit 121 of the storage unit 120, either in its original format or after modifying it to a format and content that can be provided as digital content. The design data is managed as a design ID and can be used by multiple design media as described below. Here, the above design data includes design data related to digital media. For example, the digital content with the design sold on the game platform A can he used in other digital media.

Next, as the process of step S103, the information reception unit 131 of the server terminal 100 receives a use request for design information from the digital media terminal 300. As a previous stage of this process, for example, the server terminal 100 receives from the designer terminal 200 and displays the design information list on the user interface screen of the digital media terminal 300, based on the design information stored as the design data 1000 and the designer information stored as the designer data 2000. As a list of design information, image data related to each design is displayed, and along with this, designer information, design explanation information, price information, pattern information based on shape and colour, design product information sold at real stores, information related to fashion brands, real stores, etc. selling design products, advertising information for design products sold in real stores, etc., and when design information is sold as digital contents, the relevant media information, etc., can be displayed. Further, here, the server terminal 100 presents a candidate for a digital content product to which the design is applied to a specific or unspecified user in a format such as crowdfunding with respect to the design information received from the designer, determines commercialization of the product that received the most votes and perform a product proposal along with the design for the digital media terminal 200. Alternatively, it can be developed as a real product based on design information. Here, the digital media includes, for example, Facebook (registered trademark), Yahoo! (registered trademark), game service providers that provide online games, etc. For example, in the case of a game service provider that provides an online game, as a design for items such as clothing worn by the player character appearing in the game, it can be considered using the fashionable design among the clothing designs distributed in real-world real stores or online stores. Alternatively, it is desired to digitally create a design that cannot be realized in reality, and request that the design registered in this service be used. The designs of products distributed in real stores in the real world are distributed in the form of digital contents via digital media, which can get market expansion opportunities through various digital media for designers about the design of products sold in real stores in the real world. Meanwhile, for digital media, by gaining the opportunity to use designs that are popular in the real world, this will lead to the efficient distribution of digital contents, and thus is expected to be profitable for both parties.

Next, as the process of step S104, the design information processing unit 132 of the control unit 130 of the server terminal 100 generates or updates the product information in relation to the design information that has received the usage request. As a preliminary step of this process, the server terminal 100 transmits information related to the digital media, the purpose of use, and the like to the designer terminal 200 as necessary based on the design usage request received from the digital media terminal 300. By receiving approval from the designer, it can proceed with the usage procedure. When proceeding with the usage procedure, it is also possible to proceed with the payment procedure based on the price information of the design included in the design information. Further, as a reward for the designer, it is also possible to set an amount according to the sales of the product to which the designer's design is applied by digital media. As the product information, for example, product information (provided digital media name, product image data, NFT ID, etc.) related to the product to which the design is applied can be generated or updated. The design information processing unit 132 stores the generated or updated product information in the design data storage unit 121 as design data 1000.

Further, here, the digital media information processing unit 134 of the control unit 130 of the server terminal 100 can also make a usage request and generate or update product information in relation to the digital media on which the product is sold. Here, as the product information, for example, seller information, product image data, product description information, price information, pattern information by shape, colour. etc., NFT ID, and the like can be included. The digital media information processing unit 132 stores the generated or updated product information in the digital media data storage unit 123 as digital media data 3000. By these processes, the design devised by the designer can be associated with the product information provided by the digital media.

Next, as the process of step S105, the information reception unit 131 of the server terminal 100 receives, from the digital media terminal 300, sales information related to the product as digital content to which the design is applied or the product to be developed in a real manner. The sales information includes, for example, sales information (sales amount, details, transition, etc.) of products in digital media, marketing information (user attributes, etc.), and the like. The digital media terminal 300 presents a digital content product to which the design is applied, for example, a clothing item of the player character in the game content, to the user terminal 400 in each service. Providing digital content based on the usage request from the user terminal 400, charge processing is performed, and profit is obtained therefrom. Further, when the digital media terminal 300 provides the product, the user terminal 400 is provided with information on the designer and the fashion brand, or an advertisement on the product and the like provided in a real store in the real space related to the design. Thereby, the user related to the user terminal 400 can be encouraged to purchase the product provided by the same designer in the real space. When a designer operates an online store in a real space, the user terminal 400 can be sent to a product sales landing page in the online store by linking the URI, information of the online store to a digital advertisement. Further, the server terminal 100 manages the sales of the product to which the design is applied, and a part of the sales can be distributed between the service provider operating the server terminal 100 and the designer according to the business model.

Next, as the process of step S106, the digital media information processing unit 132 of the server terminal 100 updates the product information based on the received sales information. The digital media information processing unit stores the received sales information in the digital media data storage unit 123 as digital media data 3000. In response to the request from the designer terminal 200, the server terminal 100 refers to the sales information included in the digital media data 3000, and can provide information related to the product to which the design devised by the designer is applied. Here, since the sales information includes not only the sales record but also the marketing information of the product. Based on this information, the designer can consider measures related to advertisement activities and sales promotion activities for products related to the same or similar designs sold in real stores and the like.

In the above-mentioned example, in an embodiment of selling digital contents in the primary market. an example (BtoBtoC) in which a designer provides a product to a user via a service provider and digital media has been described. In addition, examples of sales from designers to users via service providers as the primary market (B to C), and examples of sales of purchased goods from users who have purchased goods to other users as the secondary market (C to C) are also included.

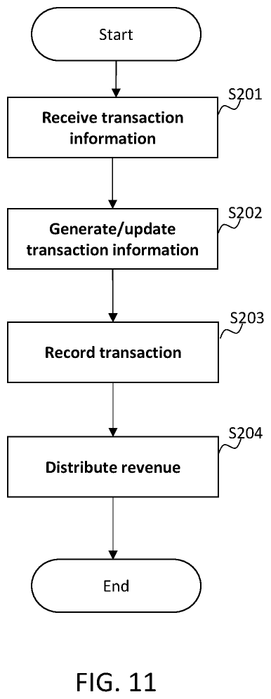

FIG. 11 is a flowchart showing a method of performing a transaction recording of digital contents according to a first embodiment of the present invention.

First, in the process of step S201, for the transaction executed in the primary market or the secondary market, the information reception unit 131 of the control unit 130 of the server terminal 100 receives transaction information from the digital media terminal 300 or the user terminal 400A or 400B that executed the transaction. The transaction information may include, for example, product information about products related to transacted digital contents (ID for associating with NFT, etc.), transactor information (information about the parties to the transaction of the product (transferor, transferee of the product)), transaction date and time (date and time when the transaction was executed, etc.), transaction price (sales price of traded products, etc.).

Next, as the process of step S202, the transaction information processing reception unit 135 of the control unit 130 of the server terminal 100 performs a process of storing or updating the transaction information based on the received transaction information. For example, the transaction information processing unit 135 refers to the transaction data storage unit 124 of the storage unit 120, associates the transaction ID with the received transaction information, and based on the transaction information, it generates or updates transaction data including product information (product image data, product description information, price information, pattern information based on shape and colour, ID for associating with NFT, etc.), right holder information (copyright holder information of copyright related to products, ownership holder of ownership (owner's right) related to products, etc.), transactor information (information related to the parties to the transaction of the product (transferor, transferee of the product)), transaction date and time (date and time when the transaction was executed, etc.), transaction prices (sales prices of traded products, etc.). Here, the right holder information and the like can also be generated with reference to the information such as the product information stored in advance. The transaction information processing unit 135 stores the generated or updated transaction information in the transaction data storage unit 124.

Next, as the process of step S203, the transaction information processing unit 135 of the control unit 130 of the server terminal 100 records the transaction information generated or updated in the previous step in the blockchain network. Here, the transaction information processing unit 135 can call the smart contract executed in the blockchain network and record the transaction information. The transaction information includes NFTID associated with the product. The procedure for transferring NFTs identified by NFTIDs between trading the parties to the transaction of products can be performed on the blockchain network via smart contracts. Here, the user can refer to the history of the past owner and the transaction price for the

NFT based on the history of the transaction information recorded in the smart contract. Thus, based on this information, the transaction price of digital content products can be determined. For example, when a celebrity has owned an NFT in the past, the transaction price of the product to be sold can be set to a high price. Alternatively, a case where the purchaser sets the price for the value by himself/herself by a method such as an auction is also conceivable. Also, since the right holder information is recorded in the smart contract, the user can refer to the right holder information about the NFT and can know the genuine right holder. This guarantees highly secure transactions. As details of the right holder information, both the copyright holder and the ownership holder can be recorded in the smart contract. In order to ensure the confidentiality of the ownership holder, the ownership holder information included in the right holder information can be stored only in the server terminal 100 without recording. It is also possible to perform the revenue sharing described in the next step. Meanwhile, by recording the owner information in the smart contract, the revenue distribution obtained based on transactions can be referred, and highly transparent transactions can be secured.

Next, as the process of step S204, the transaction information processing unit 135 of the control unit 130 of the server terminal 100 executes the revenue distribution process. For example, as described with reference to FIG. 9, the transaction information processing unit 135 refers to the right holder information included in the transaction data 4000 stored in the transaction data storage unit 124 of the recording unit 120. For a specific product transacted, the owner of the product and the profit distribution ratio are determined based on whether the product was sold to the user from digital media as a primary market, or as a secondary market between users. Revenue is apportioned with respect to the selling price of digital content products transferred to users and/or the royalties obtained from digital media, and the process of executing payment is performed. For example, as a primary market, products are sold to users from digital media. When the ownership holder included in the right holder information is set as a designer and a service provider, the selling price is apportioned by 90% and 10% as a service fee between the designer and the service provider. For transactions in the secondary market, for example, it can be decided to apportion and distribute the commission received by the service provider by 50% and 50%. Also, regarding the distribution of royalties obtained based on the sales of digital media related to products, when the owner is set to the designer, the service provider, and the user, it can be decided to distribute to 40%, 30%, and 30%, respectively. Here, regarding royalties, in addition to sales-based royalties, when a third party infringes design-related rights, it may also include royalties collected as a result of the design media exercising its rights against a third party. Also, in this example, the distribution of revenue can be executed via cryptographic assets that can be exchanged for NFTs (for example, “Ether” in the case of Ethereum platform).

As described above, by managing digital content products in relation to NFTs and recording transaction information on the blockchain network, it is possible to guarantee the security of the transaction as non-tampering of the data, and the transparency of the right and the transaction based on the records of the rights and the parties to the transaction. Additionally, the profits obtained from the transaction are based on the rights information recorded in the blockchain network, and it is possible to efficiently and appropriately distribute profits while reducing the distribution cost. In this way, revenue is distributed to designers, service providers and/or users who have contributed to the creation or transaction of digital content products. Designers can earn money for their creations and can make an investment in creating a new design. Since users try to maximize the profit opportunity of the product, the distribution of the product can be promoted. For example, a user who is an influencer of SNS actively promotes digital content products to followers, or by having a well-known user own a digital content product, it is possible to distribute the product as a high-value product while performing branding, thereby building an ecosystem in which product distribution is activated.

Although embodiments according to the invention have been described above, these can be implemented in various other embodiments, and can be implemented with various omissions, replacements and changes. These embodiments and variations as well as those with omissions, substitutions and modifications are included in the technical scope of the claims and the equivalent scope thereof

### DESCRIPTION OF REFERENCE NUMERALS

1: system
100: server terminal
110: communication unit
120: storage unit
130: control unit
200: designer terminal
300: digital media terminal
400: user terminal
NW1: network

1. A method for providing digital contents, wherein a control unit of a server terminal comprises:
receiving transaction information of digital contents from a user terminal; and
recording the transaction information in a blockchain as transaction information associated with a non-fungible token associated with the digital contents,
wherein the transaction information comprises at least right holder information of the digital contents, and
wherein the right holder information comprises copyright holder information and/or ownership holder information.

2. The method according to claim 1,
wherein the ownership holder information comprises at least designer information that devised the digital contents, service provider information that mediates transactions of the design contents, and user information that is a party who performs transaction of the digital contents.

3. The method according to claim 1,
wherein the copyright holder information comprises at least designer information that devised the digital contents and service provider information that mediates transaction of the design contents.

4. The method according to claim 2,
which executes a revenue distribution process for each terminal of the owner included in the owner information based on the ownership holder information.

5. The method according to claim 1,
wherein the transaction information comprises transaction information for performing a transaction of the digital contents.
